(19) United States
(12) Patent Application Publication
(10) Pub. No.: US 2011/0121888 A1
(43) Pub. Date: May 26, 2011

(54) LEAKAGE CURRENT COMPENSATION

(76) Inventors: Dario Giotta, Tarvisio (IT); Martin Clara, Villach (AT)

(21) Appl. No.: 12/623,487

(22) Filed: Nov. 23, 2009

(51) Int. Cl. G05F 1/10

(52) U.S. Cl. 327/538

(57) ABSTRACT

Implementations related to compensating for on-current leakage associated with current source arrangements are disclosed. An implementation may be provided that includes a replicated current mirror output stage. A circuit may be disposed between a current mirror output stage and the replicated current mirror output stage. The circuit may be implemented to drive a voltage associated with the current mirror output stage to a voltage level associated with the replicated current mirror output stage. A current may be supplied by the circuit to drive the voltage associated with the current mirror output stage. In one implementation, the current is substantially equal to an on-current leakage associated with the current mirror output stage.

### BACKGROUND

Current sources/mirrors are used in many circuits, such as oscillators, amplifiers, data converters and biasing circuits. Current sources are often fabricated as part of integrated circuits (ICs). As the technology related to the fabrication of ICs improves, the size of the transistors used tends to drop. This is not always true for current mirrors, especially if high accuracy is required.

Complementary metal oxide semiconductor (CMOS) is a technology that is used to create today's ICs. CMOS uses p-type and n-type metal oxide semiconductor field effect transistors (MOSFETs) to achieve the functionality associated with an IC. The transistors used in today's nano-scale CMOS processes have very thin gate insulating films. The thin gate insulating films may be created by technology scaling, which drives the voltage threshold (Vₜ) lower in order to improve the transistor's operational speed. However, thin gate insulating films may directly cause undesirable current-leakage at the gate, also referred to as gate current leakage or on-state current leakage.

On-state current leakage in contemporary nano-scale CMOS current sources may cause a discrepancy between a reference current and an output current. This problem is exasperated if the reference current is to be mirrored so as to provide a plurality of constant currents, based on the reference current, to various elements of an IC. In particular, as the number of constant currents increases, such as in a current mirror arrangement, the discrepancy between a current value of the reference current and the current value of the constant currents generated by the current mirror arrangement may be rather significant. On-state current leakage may be a greater problem in current mirrors that are designed to have high accuracy. In particular, such current mirrors generally require larger transistors, which inherently produce more leakage than smaller transistors.

Conventional bipolar current source implementations use the so called base current compensation technique to compensate for a current discrepancy between a reference current and an output current. For example, assume a conventional bipolar current mirror incorporates two bipolar transistors having coupled bases, where a reference transistor thereof is diode connected (i.e., the base and collector thereof are shorted). An additional transistor is added, where the emitter thereof is coupled between the bases of the two bipolar transistors, and the base of the additional transistor is connected to the collector of the reference transistor. As those of ordinarily skill in the art appreciate, the inherent properties of the circuit with the additional transistor facilitate reducing the current discrepancy between the reference current and the output current.

The base current compensation technique does not translate to CMOS current source implementations. That is, the MOS transistors used to implement CMOS current sources do not have the same inherent properties exhibited by bipolar transistors. Therefore, a CMOS current source arrangement constructed in the manner described in the foregoing does not reduce a current discrepancy between a reference current and the output current.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different instances in the description and the figures may indicate similar or identical items.

FIG. 1 is a circuit diagram illustrating one implementation of an on-leakage compensated current mirror.

FIG. 2 is a circuit diagram illustration of an exemplary current source that may be used to generate a reference current.

FIG. 3 illustrates an exemplary procedure to compensate for on-leakage current.

### DETAILED DESCRIPTION

The following description describes implementations related to compensating for on-current leakage associated with current source arrangements. An implementation may be provided that includes a replicated current mirror output stage. A circuit may be disposed between a current mirror output stage and the replicated current mirror output stage. The circuit may be implemented to drive a voltage associated with the current mirror output stage to a voltage level associated with the replicated current mirror output stage. A current may be supplied by the circuit to drive the voltage associated with the current mirror output stage. In one implementation, the current is substantially equal to an on-current leakage associated with the current mirror output stage.

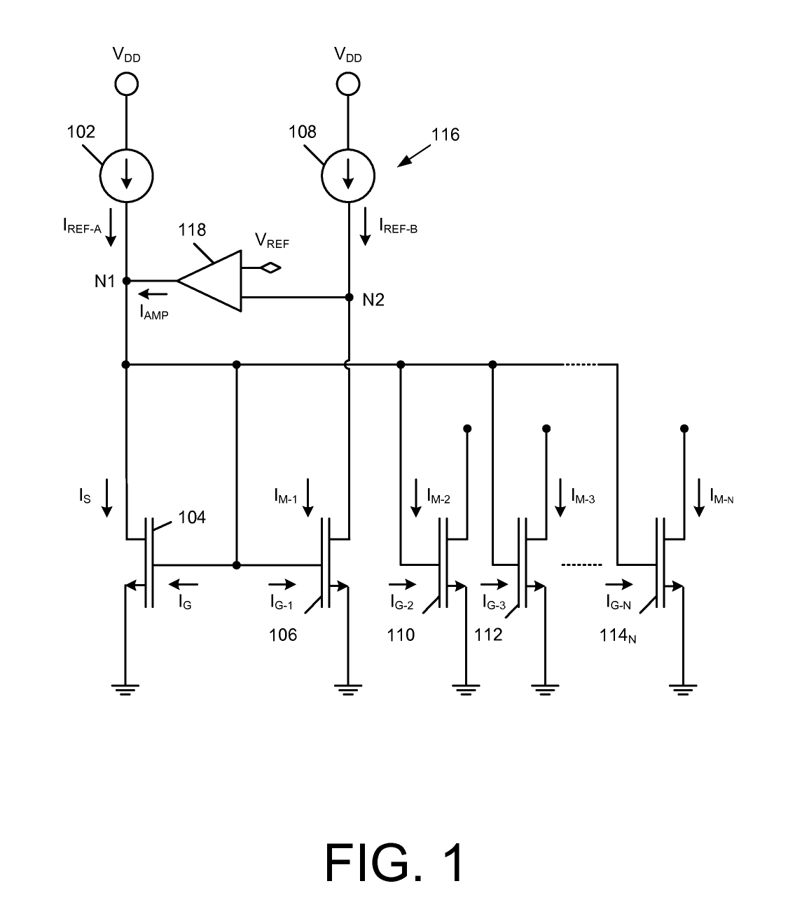

FIG. 1 is a circuit diagram illustrating one implementation of an on-leakage current compensated current mirror 100. The term on-leakage current generally relates to gate current leakage that manifests when the current mirror 100 is operational or in an on-state. In general, the current mirror 100 is operational when a current source 102 is supplying a reference current I_{REF-A}. Gate current leakage that occurs when the current mirror 100 is operational will be described in greater detail in the following disclosure.

In a basic implementation, the current mirror 100 may include an N-FET 104 and an N-FET 106. The source of the N-FET 104 may be coupled to ground. Ground, as used herein, may be circuit ground, for example a low power supply V_{SS}. A gate of the N-FET 104 may be coupled to a drain thereof. The drain of the N-FET 104 may be coupled to the current source 102. The N-FET 106 may also have the source coupled to ground. A gate of the N-FET 106 may be coupled to the gate of the N-FET 104. Assuming a subsequent current source 108 coupled to V_{DD} is ignored or eliminated from FIG. 1, a drain of the N-FET 106 may provide an output current I_{M-1}.

During and on-state of the current mirror 100, and under ideal conditions, a gate to source voltage V_{GS} of the N-FET 104 may be set to a level that allows the reference current I_{REF-A} generated by the current source 102 to pass through the N-FET 104. Because the gates of the N-FET 104 and N-FET 106 are coupled and the sources thereof are also coupled, the V_{GS} of the N-FET 106 may be equal to the V_{GS} of the N-FET 104. Accordingly, if the N-FET 104 and N-FET 106 are identical, the N-FET 106 may provide an output current I_{M-1} that is identical to the reference current I_{REF-A}. The N-FET 106 may be forced to provide this identical output current I_{M-1}, because the V_{GS} of the N-FET 106 may be equal to the V_{GS} of the N-FET 104. Therefore, the N-FET 106 may be considered a current source that mirrors the behavior of the N-FET 104. In another implementation, the N-FET 106 may not be identical to the N-FET 104. That is, a width and/or length ratios of the gates associated with the N-FETs 104 and 106 may not be the same. In such an implementation, the output current I_{M-1} may be different than the reference current I_{REF-A} flowing through the N-FET 104.

Continuing to assume the subsequent reference current source I_{REF-B} 108 coupled to V_{DD} is ignored or eliminated from FIG. 1, additional N-FETs 110-114_{N} may be implemented as part of the current mirror 100. Each of gate of the N-FETs 110-114_{N} may be coupled to the gate of the N-FET 104. A source of each of the N-FETs 110-114_{N} may be coupled to ground. Therefore, because each respective gate of the N-FETs 110-114_{N} may be coupled to the gate of the N-FET 104 and the sources thereof are also coupled, the V_{GS} of the N-FET 104 may be equal to the respective V_{GS} of each of the N-FETs 110-114_{N}. Accordingly, if all the N-FETs 104 and 110-114N are identical, the N-FETs 110-114_{N} may provide output currents I_{M-2}, I_{M-3} and I_{M-N}, respectively, that are identical to the reference current I_{REF-A}. In another implementation, the N-FETs 110-114_{N} may not be identical to the N-FET 104. That is, a width and/or length ratios of the gates associated with the N-FETs 104 and N-FETs 110-114_{N} may not be the same. In such an implementation, the output currents I_{M-2}, I_{M-3} and I_{M-N} may be different than the reference current I_{REF-A} flowing through the N-FET 104. The output currents I_{M-2}, I_{M-3} and I_{M-N} may be supplied to various circuit elements associated with an IC.

As indicated above, on-leakage current occurs when the current mirror 100 is an operational state. The on-leakage current flowing through each of the N-FETs 104-114_{N} is shown as I_{G}-I_{G-N}. As indicated, on-leakage current may be undesirable, as such current may create a significant mirroring error as the number of parallel N-FETs for supplying output currents increases. Ideally, an output current I_{S} supplied by the N-FET 104 would be equal to the reference current I_{REF-A}. However, due to the on-leakage current, the output current I_{S} may be expressed as:

I_{S}=I_{REF-A}−I_{G}−I_{G-1}−I_{G-2}−I_{G-3}− . . . −I_{G-N}.

This output current I_{S} is that which is mirrored by the NFETs 106-114_{N}. That is, assuming the N-FETs 106-114_{N} are identical to the N-FET 104, the output currents Iₘ₋₁, I_{M-2}, I_{M-3} and I_{M-N} may each equal the output current I_{S}, and not I_{REF-A} as ideally expected

More generally, assuming each of the N-FETs 104-114_{N} is identical, the total on-leakage current may be expressed as:

I_{GTOTAL}=(N+1)×I_{G},

where N is the number of current sources mirroring the behavior of the N-FET 104.
Therefore, the output current I_{S} may be simplified as:

I_{S}=I_{REF-A}−I_{GTOTAL}.

The current mirror 100 illustrated in FIG. 1 may be configured to compensate for on-leakage current. To realize on-leakage current compensation, a current source that mirrors the behavior of the N-FET 104 may be implemented as a replica arrangement 116. In one implementation, the replica arrangement 116 may include the N-FET 106 and the subsequent reference current source 108 coupled to V_{DD}. The subsequent reference current source 108 may supply a reference current I_{REF-B}. An operational amplifier 118, which in one implementation is an operational transconductance amplifier (OTA), may be coupled between the reference current sources 102 and 108. An output of the amplifier 118 may be coupled to a node N1. A first input of the amplifier may be coupled to a node N2, and a second input thereof may be coupled to a reference voltage V_{REF}.

The operational characteristics that enable the replica arrangement 116 and the operational amplifier 118 to compensate for on-leakage current are described in the following. The subsequent reference current source 108 may be implemented to supply the reference current I_{REF-B} that is substantially equal to the reference current I_{REF-A} supplied by the reference current source 102. If the current mirror were ideal (e.g., no on-leakage current), the output current I_{M-1} would be equal to the reference current I_{REF-B} supplied by the subsequent reference current source 108. Moreover, in such an ideal case, a voltage seen at the node N1 may be equal to the voltage seen at the node N2. However, in actuality, due to the total on-current leakage current I_{GTOTAL}, the output current I_{S} may not be the same current value as the reference current I_{REF} produced by the reference current source 102. Thus, the voltage seen at the node N1 may settle to a value that is different than the voltage seen at the node N2. More specifically, as those of ordinary skill appreciate, the N-FET 104 is biased like a diode. Accordingly, once a current is flowing through the N-FET 104, the voltage seen at the node N1 may correspond to the V_{GS} of the N-FET 104. Because the output current I_{S} may be reduced by an amount of the total on-current leakage current I_{GTOTAL}, the voltage seen at the node N1 may be lower as a direct result of the total on-current leakage current I_{GTOTAL}. In general, the total on-current leakage current I_{GTOTAL} may cause the voltage seen at the node N1 to be lower than the voltage seen at the node N2.

In one implementation, the operational amplifier 118 may be implemented to drive the voltage seen at the node N1 higher with the goal of achieving a voltage equilibrium or balanced state at nodes N1 and N2. That is, the operational amplifier 118 may be implemented to minimize the voltage difference between the reference voltage V_{REF} and the voltage seen at node N2. Therefore, the reference voltage V_{REF} value may be chosen such that an amplifier current I_{AMP} generated by the operational amplifier 118 drives the voltage seen at node N1 to equal a voltage seen at the node N2. In one implementation, the V_{REG} value may be chosen such that the amplifier current I_{AMP} generated by the operational amplifier 118 substantially equals the total on-current leakage current I_{GTOTAL} of the current mirror 100. In general, the amplifier current I_{AMP} generated by the operational amplifier 118 is a current value that substantially satisfies the following equation:

I_{AMP}+I_{S}=I_{REF-A}.

In accordance with the foregoing, the replica arrangement 116 and the operational amplifier 118 provide a feedback loop arrangement that may generate a current that offsets a difference between the output current I_{S}, which may be reduced by the total on-current leakage current I_{GTOTAL} of the current mirror 100, and the reference current I_{REF-A} supplied by the reference current source 102. As should be appreciated from the above, the feedback loop arrangement may compensate for variations of the on-current leakage current caused or indirectly caused by variations in process, temperature, supply and the like.

The on-leakage current compensated current mirror 100 has been illustrated and described as being implemented with N-FET devices. However, the same on-leakage current techniques used to compensate for gate leakage in the current mirror 100 are also applicable to current mirrors that implement P-FET devices and mirrors that are implemented using other devices or circuit arrangements.

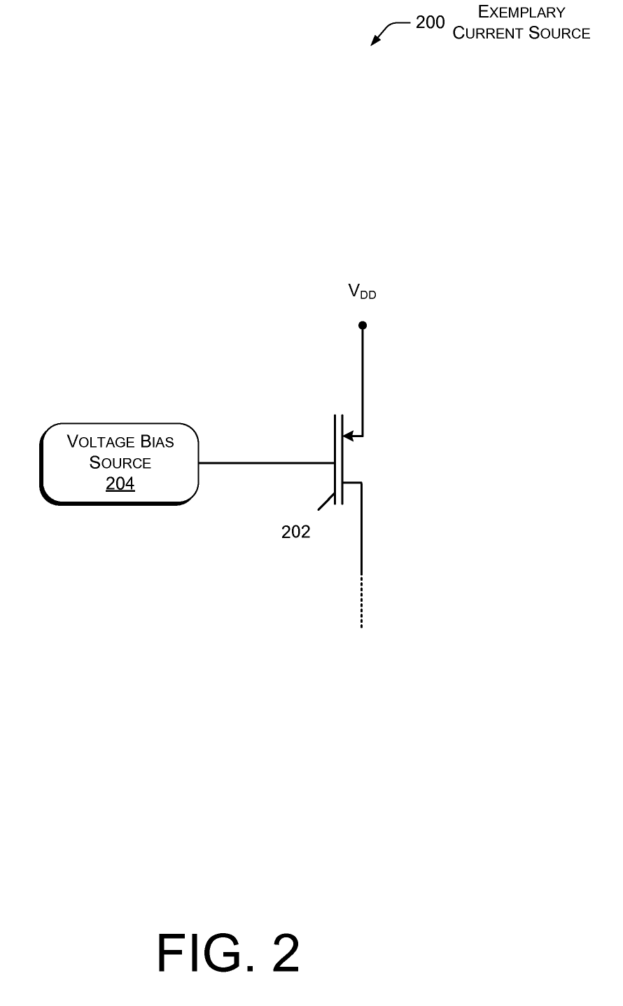

FIG. 2 is a circuit diagram illustration of an exemplary current source 200 that may be used to generate a reference current. The current source 200 may be used to realize the reference current sources 102 and 108 illustrated in FIG. 1. The current source 200 may be configured to include a P-FET 202. A source of the P-FET 202 may be coupled to VDD. A gate of the P-FET 202 may be coupled to a voltage bias source 204. The voltage bias source 204 may generate a voltage that biases the P-FET 202.

Specifics of exemplary procedures are described below. However, it should be understood that certain acts need not be performed in the order described, and may be modified, and/or may be omitted entirely, depending on the circumstances.

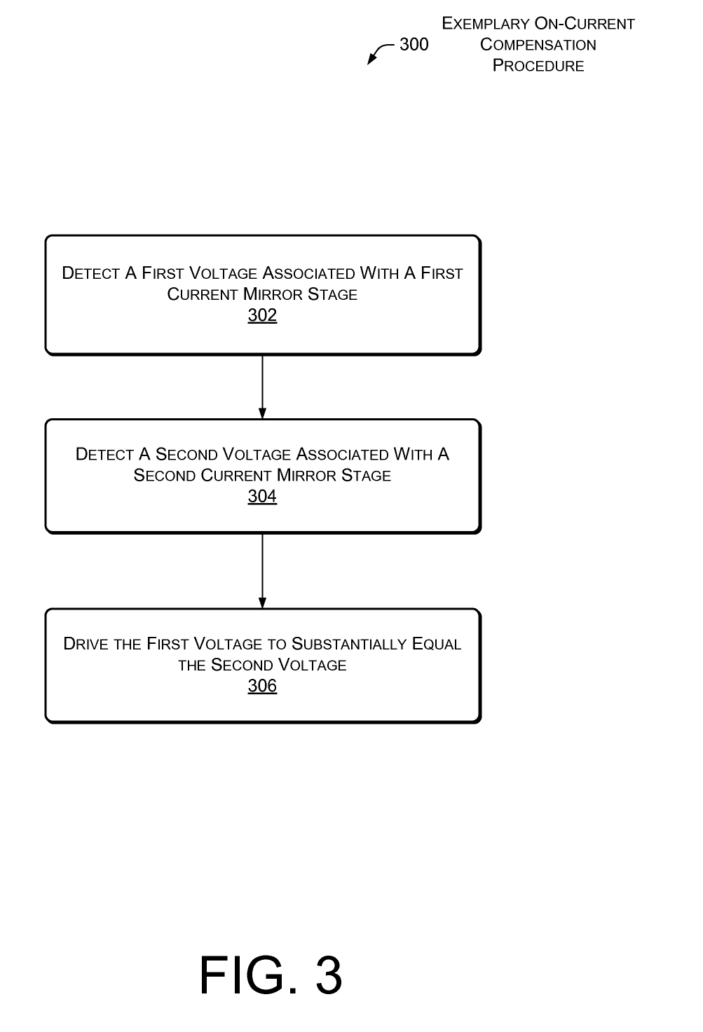

FIG. 3 illustrates an exemplary procedure 300 to compensate for on-leakage current. The exemplary procedure 300 may be performed by the on-leakage current compensated current mirror 100 illustrated in FIG. 1. Moreover, the procedure 300 may be implemented by other circuit arrangements so designed to provide on-leakage current compensation according to the implementations disclosed herein.

At Act 302, a first voltage associated with a first current mirror stage is detected. For example, a voltage at the node N1 may be detected or determined. At Act 304, a second voltage associated with a second current mirror stage is detected. For example, a voltage at the node N2 may be detected and determined. At Act 306, the voltage at the node N1 is driven to substantially equal the voltage detected at the node N2.

In Act 304, the second current mirror stage may be a replica of the first current mirror stage. Both the first and second current mirror stages may include a reference current source coupled to a drain of a transistor, where the reference current sources and the transistors are substantially the same. In Act 306, driving the voltage at the node N1 may include supplying a current to the node N1 that is substantially equal to an on-leakage current associated with the first current mirror output stage. Furthermore, in Act 306, the current may be supplied by an OTA, such as the amplifier 118.

For the purposes of this disclosure and the claims that follow, the terms “coupled” and “connected” have been used to describe how various elements interface. Such described interfacing of various elements may be either direct or indirect. Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. The specific features and acts described in this disclosure and variations of these specific features and acts may be implemented separately or may be combined.

1. An apparatus, comprising:
a first transistor to supply an output current;
a replica circuit including a second transistor coupled to a current source, the current source to generate a reference current substantially equal to another reference current received by the first transistor; and
an operational amplifier coupled to the first and second transistors, the operational amplifier to supply a current that offsets a difference between the output current and the another reference current.

2. The apparatus according to claim 1, further comprising another current source to supply the another reference current.

3. (canceled)

4. The apparatus according to claim 3, wherein the operational amplifier includes an output coupled to a first node defined between a drain of the first transistor and an output of another current source to supply the another reference current, a first input coupled to second node defined between a drain of the second transistor and an output of the current source, and a second input coupled to a reference voltage.

5. The apparatus according to claim 4, wherein the current drives a first voltage to substantially equal a second voltage, the first voltage being on the first node and the second voltage being on the second node, the reference voltage set to a voltage value that enables the operational amplifier to drive the first voltage to substantially equal the second voltage.

6. An apparatus, comprising:
a current source to supply a reference current;
a first transistor to supply an output current based on the reference current; and
an operational transductance amplifier (OTA) coupled to a node defined between the current source and the first transistor, the circuit to supply a current to the node that is at least substantially equal to an on-leakage current associated with the first transistor,
wherein the OTA is to supply the current based on voltage level seen in a replica circuit including another current source that is substantially the same as the current source and a second transistor that is substantially that same as the first transistor.

7. The apparatus according to claim 6, wherein the current supplied by the circuit summed with the on-leakage current substantially equals the reference current supplied by the current source.

8. (canceled)

9. The apparatus according to claim 8, wherein the OTA includes an output coupled to the node, a first input coupled to another node defined between the another current source and the second transistor, and a second input coupled to a voltage reference, the current generated on the output of the OTA to drive a voltage at the node higher.

10. The apparatus according to claim 9, wherein the current supplied on the output of the OTA drives the voltage at the node to a level that substantially equals another voltage at the another node.

11. A method, comprising:
detecting a first voltage associated with a first current mirror output stage; and
detecting a second voltage associated with a second current mirror output stage, the second current mirror output stage being a replicated version of the first current mirror output stage;
driving the first voltage to substantially equal the second voltage,
wherein the driving includes providing an operational transductance amplifier (OTA) to the supply current.

12. The method according to claim 11, further comprising, in the first current mirror output stage, providing a first reference current source and a first transistor having a drain coupled to an output of the first reference current source, the replicated version of the first current mirror output stage including a second reference current source and a second transistor being the substantially the same as the first reference current source and the first transistor.

13. The method according to claim 11, wherein the driving act includes supplying a current to drive the first voltage to substantially equal the second voltage.

14. The method according to claim 13, wherein the current is substantially equal to an on-leakage current associated with the first current mirror output stage.

15. (canceled)

16. An apparatus, comprising:
a first transistor to supply an output current;
a replica circuit including a second transistor coupled to a current source, the current source to generate a reference current substantially equal to another reference current received by the first transistor; and
an operational amplifier coupled to the first and second transistors, the circuit to supply a current that drives a first voltage to substantially equal a second voltage.

17. The apparatus according to claim 16, further comprising another current source to supply the another reference current.

18. (canceled)

19. The apparatus according to claim 18, wherein the operational amplifier includes an output coupled to first node defined between a drain of the first transistor and an output of another current source to supply the another reference current, a first input coupled to second node defined between a drain of the second transistor and an output of the current source, and a second input coupled to a reference voltage.

20. The apparatus according to claim 19, wherein the first voltage is on the first node and the second voltage is on the second node, the reference voltage set to a voltage value that enables the operational amplifier to drive the first voltage to substantially equal the second voltage.
